(19) United States
(12) Patent Application Publication
(10) Pub. No.: US 2011/0116665 A1
(43) Pub. Date: May 19, 2011

(54) SYSTEM AND METHOD OF PROVIDING THREE-DIMENSIONAL SOUND AT A PORTABLE COMPUTING DEVICE

(76) Inventors: Bennett M. King, San Diego, CA (US); Robert S. Tartz, San Marcos, CA (US); James B. Cary, San Diego, CA (US)

(21) Appl. No.: 12/619,983

(22) Filed: Nov. 17, 2009

(51) Int. Cl. H04R 5/02

(52) U.S. Cl. 381/300

(57) ABSTRACT

A method of providing three-dimensional (3D) sound at a wireless device is disclosed and may include detecting movement of a 3D virtual object within a display, determining a direction of the movement of the 3D virtual object, and transmitting sound from a 3D sound system that tracks the direction of the movement of the 3D virtual object. The method may further include selectively altering a phase of the sound as the 3D virtual object moves, selectively altering a volume of the sound as the 3D virtual object moves, selective altering a pitch of the sound as the 3D virtual object moves, selectively altering a tone of the sound as the 3D virtual object moves, or a combination thereof.

### DESCRIPTION OF THE RELATED ART

Portable computing devices (PCDs) are ubiquitous. These devices may include cellular telephones, portable digital assistants (PDAs), portable game consoles, palmtop computers, and other portable electronic devices. Many portable computing devices include a touch screen interface in which a user may interact with the device and input commands. Further, the touch screen interface may be used to display multiple items, e.g., application icons, thumbnails, tiles, or a combination thereof.

Some of the items displayed may include three-dimensional (3D) virtual objects that may move about within the display. As these 3D virtual objects are displayed, one or more sounds may be broadcast from the PCD.

Accordingly, what is needed is an improved method of providing 3D sound at a portable computing device.

### BRIEF DESCRIPTION OF THE DRAWINGS

In the figures, like reference numerals refer to like parts throughout the various views unless otherwise indicated.

FIG. 1 is a front plan view of a first aspect of a portable computing device (PCD) in a closed position;

FIG. 2 is a front plan view of the first aspect of a PCD in an open position;

FIG. 3 is a block diagram of the first aspect of a PCD;

FIG. 4 is a cross-sectional view of a second aspect of a PCD;

FIG. 5 is another cross-sectional view of the second aspect of a PCD;

FIG. 6 is a cross-sectional view of a third aspect of a PCD;

FIG. 7 is a flowchart illustrating a first aspect of a method of providing 3D sound at a portable computing device;

FIG. 8 is a first portion of a flowchart illustrating a second aspect of a method of providing 3D sound at a portable computing device;

FIG. 9 is a second portion of the flowchart illustrating a second aspect of a method of providing 3D sound at a portable computing device;

FIG. 10 is a third portion of the flowchart illustrating a second aspect of a method of providing 3D sound at a portable computing device;

FIG. 11 is a fourth portion of the flowchart illustrating a second aspect of a method of providing 3D sound at a portable computing device;

FIG. 12 is a first portion of a flowchart illustrating a third aspect of a method of providing 3D sound at a portable computing device;

FIG. 13 is a second portion of the flowchart illustrating a third aspect of a method of providing 3D sound at a portable computing device;

FIG. 14 is a third portion of the flowchart illustrating a third aspect of a method of providing 3D sound at a portable computing device;

FIG. 15 is a fourth portion of the flowchart illustrating a third aspect of a method of providing 3D sound at a portable computing device;

FIG. 16 is a first front plan view of a fourth aspect of a portable computing device;

FIG. 17 is a second front plan view of the fourth aspect of a portable computing device;

FIG. 18 is a third front plan view of the fourth aspect of a portable computing device;

FIG. 19 is a fourth front plan view of the fourth aspect of a portable computing device; and

FIG. 20 is a fifth front plan view of the fourth aspect of a portable computing device.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, au “application” referred to herein, may also include files that are not executable in nature, such as documents that may need to be opened or other data files that need to be accessed.

The term “content” may also include files having executable content, such as: object code, scripts, byte code, markup language files, and patches. In addition, “content” referred to herein, may also include files that are not executable in nature, such as documents that may need to be opened or other data files that need to be accessed.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

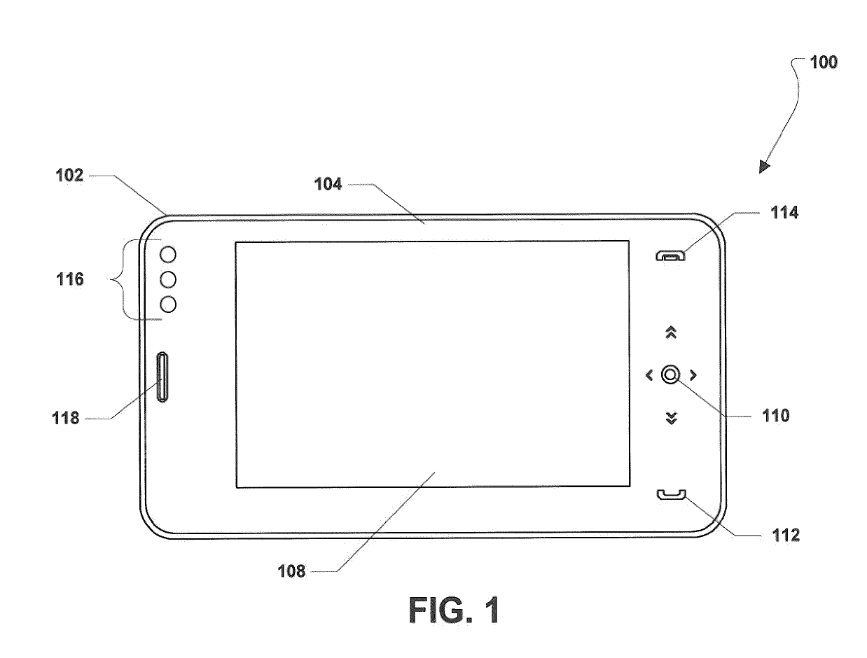

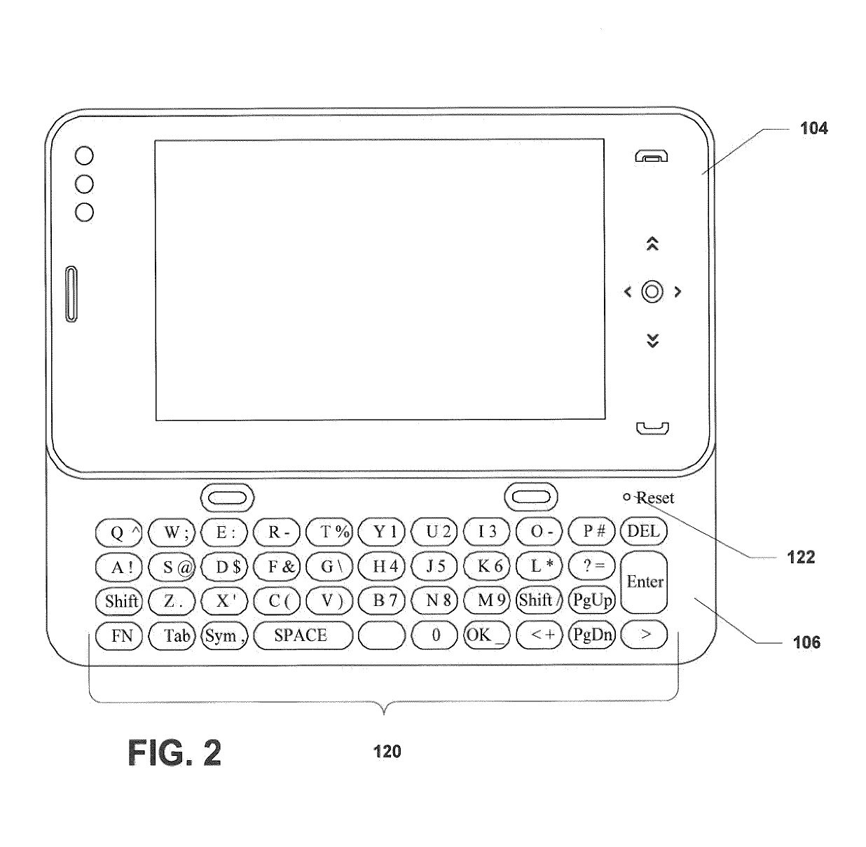

Referring initially to FIG. 1 and FIG. 2, an exemplary portable computing device (PCD) is shown and is generally designated 100. As shown, the PCD 100 may include a housing 102. The housing 102 may include a top housing portion 104 and a lower housing portion 106. FIG. 1 shows that the top housing portion 104 may include a display 108. In a particular aspect, the display 108 may be a touch screen display. The top housing portion 104 may also include a trackball input device 110. Further, as shown in FIG. 1, the top housing portion 104 may include a power on button 112 and a power off button 114. As shown in FIG. 1, the top housing portion 104 of the PCD 100 may include a plurality of indicator lights 116 and a speaker 118. Each indicator light 116 may be a light emitting diode (LED).

In a particular aspect, as depicted in FIG. 2, the top housing portion 104 is movable relative to the lower housing portion 106. Specifically, the top housing portion 104 may be slidable relative to the lower housing portion 106. As shown in FIG. 2, the lower housing portion 106 may include a multi-button keyboard 120. In a particular aspect, the multi-button keyboard 120 may be a standard QWERTY keyboard. The multi-button keyboard 120 may be revealed when the top housing portion 104 is moved relative to the lower housing portion 106. FIG. 2 further illustrates that the PCD 100 may include a reset button 122 on the lower housing portion 106.

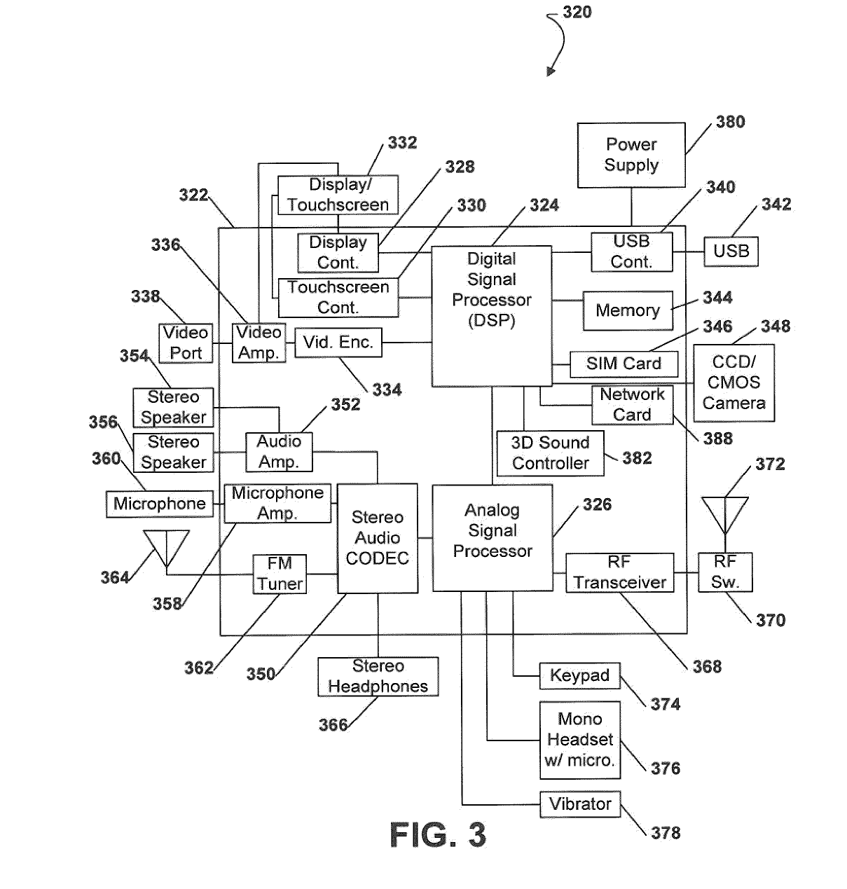

Referring to FIG. 3, an exemplary, non-limiting aspect of a portable computing device (PCD) is shown and is generally designated 320. As shown, the PCD 320 includes an on-chip system 322 that includes a digital signal processor 324 and an analog signal processor 326 that are coupled together. The on-chip system 322 may include more than two processors. For example, the on-chip system 322 may include four core processors and an ARM 11 processor, i.e., as described below in conjunction with FIG. 32.

As illustrated in FIG. 3, a display controller 328 and a touch screen controller 330 are coupled to the digital signal processor 324. In turn, a touch screen display 332 external to the on-chip system 322 is coupled to the display controller 328 and the touch screen controller 330.

FIG. 3 further indicates that a video encoder 334, e.g., a phase alternating line (PAL) encoder, a sequential couleur a memoire (SECAM) encoder, or a national television system(s) committee (NTSC) encoder, is coupled to the digital signal processor 324. Further, a video amplifier 336 is coupled to the video encoder 334 and the touch screen display 332. Also, a video port 338 is coupled to the video amplifier 336. As depicted in FIG. 3, a universal serial bus (USB) controller 340 is coupled to the digital signal processor 324. Also, a USB port 342 is coupled to the USB controller 340. A memory 344 and a subscriber identity module (SIM) card 346 may also be coupled to the digital signal processor 324. Further, as shown in FIG. 3, a digital camera 348 may be coupled to the digital signal processor 324. In an exemplary aspect, the digital camera 348 is a charge-coupled device (CCD) camera or a complementary metal-oxide semiconductor (CMOS) camera.

As further illustrated in FIG. 3, a stereo audio CODEC 350 may be coupled to the analog signal processor 326. Moreover, an audio amplifier 352 may coupled to the stereo audio CODEC 350. In an exemplary aspect, a first stereo speaker 354 and a second stereo speaker 356 are coupled to the audio amplifier 352. FIG. 3 shows that a microphone amplifier 358 may be also coupled to the stereo audio CODEC 350. Additionally, a microphone 360 may be coupled to the microphone amplifier 358. In a particular aspect, a frequency modulation (FM) radio tuner 362 may be coupled to the stereo audio CODEC 350. Also, an FM antenna 364 is coupled to the FM radio tuner 362. Further, stereo headphones 366 may be coupled to the stereo audio CODEC 350.

FIG. 3 further indicates that a radio frequency (RF) transceiver 368 may be coupled to the analog signal processor 326. An RF switch 370 may be coupled to the RF transceiver 368 and an RF antenna 372. As shown in FIG. 3, a keypad 374 may be coupled to the analog signal processor 326. Also, a mono headset with a microphone 376 may be coupled to the analog signal processor 326. Further, a vibrator device 378 may be coupled to the analog signal processor 326. FIG. 3 also shows that a power supply 380 may be coupled to the on-chip system 322. In a particular aspect, the power supply 380 is a direct current (DC) power supply that provides power to the various components of the PCD 320 that require power. Further, in a particular aspect, the power supply is a rechargeable DC battery or a DC power supply that is derived from an alternating current (AC) to DC transformer that is connected to an AC power source.

FIG. 3 indicates that the PCD 320 may include a 3D sound controller 382. The 3D sound controller 382 may be a stand-alone controller or it may be within the memory 344. Further, the 3D sound controller 382, alone or in conjunction with the processors 324, 326, may serve as a means for executing one or more of the method steps described herein.

FIG. 3 further indicates that the PCD 320 may also include a network card 388 that may be used to access a data network, e.g., a local area network, a personal area network, or any other network. The network card 388 may be a Bluetooth network card, a WiFi network card, a personal area network (PAN) card, a personal area network ultra-low-power technology (PeANUT) network card, or any other network card well known in the art. Further, the network card 388 may be incorporated into a chip, i.e., the network card 388 may be a full solution in a chip, and may not be a separate network card 388.

As depicted in FIG. 3, the touch screen display 332, the video port 338, the USB port 342, the camera 348, the first stereo speaker 354, the second stereo speaker 356, the microphone 360, the FM antenna 364, the stereo headphones 366, the RF switch 370, the RF antenna 372, the keypad 374, the mono headset 376, the vibrator 378, and the power supply 380 are external to the on-chip system 322.

In a particular aspect, one or more of the method steps described herein may be stored in the memory 344 as computer program instructions. These instructions may be executed by the processors 324, 326, the controllers 328, 330, 382, or a combination thereof in order to perform the methods described herein. Further, the processors 324, 326, the memory 344, the 3D sound controller 382, the display controller 328, the touch screen controller 330, or a combination thereof may serve as a means for executing one or more of the method steps described herein in order to provide 3D sound at the PCD 320.

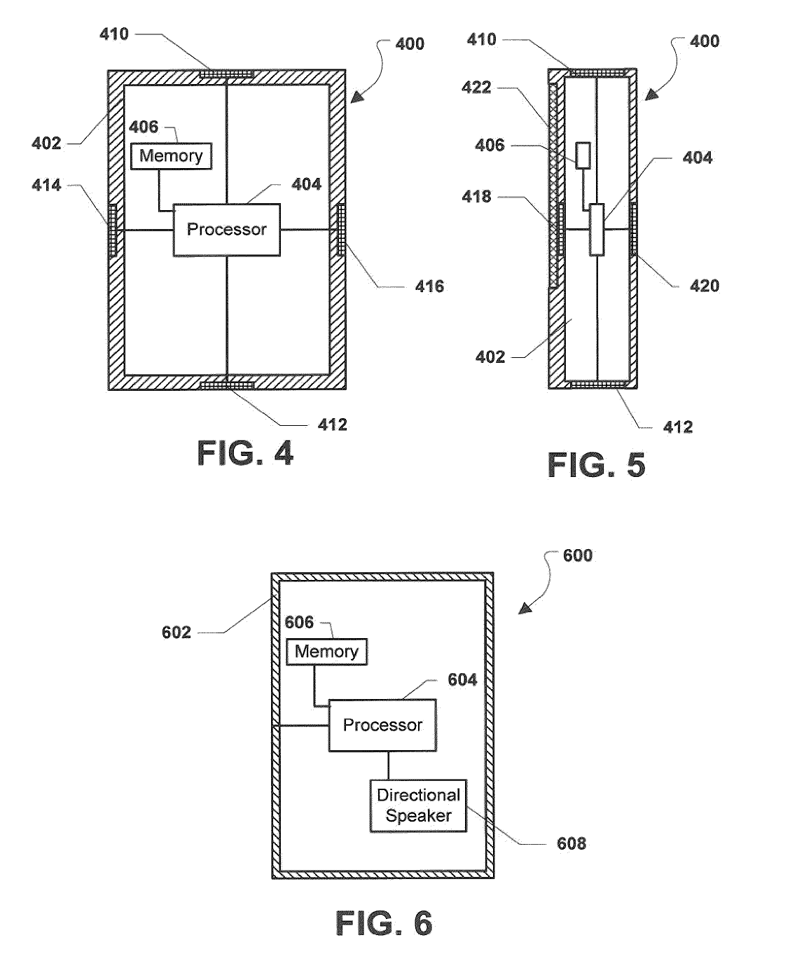

FIG. 4 and FIG. 5 illustrate another aspect of a PCD, generally designated 400. FIG. 4 and FIG. 5 show the PCD 400 in cross-section. As shown, the PCD 400 may include a housing 402. In a particular aspect, one or more of the elements shown in conjunction with FIG. 3 may be disposed, or otherwise installed, within the inner housing 402. However, for clarity, only a processor 404 and a memory 406, connected thereto, are shown within the housing 402.

FIG. 4 and FIG. 5 indicate that a top speaker 410 and a bottom speaker 412 may be installed in, or otherwise disposed on, the housing 402. Moreover, a left speaker 414 and a right speaker 416 may be installed in, or otherwise disposed on, the housing 402. FIG. 5 further illustrates that the PCD 400 may include a front speaker 418 and a back speaker 420 may be installed in, or otherwise disposed on, the housing 402. The speakers 410, 412, 414, 416, 418, 420 may serve as a 3D sound system. Further, as 3D virtual objects are displayed, the 3D sound system may be activated and may provide 3D sound associated with the 3D virtual object in accordance with one or more of the methods described herein.

It may be appreciated that the 3D sound system may include additional speakers, e.g., a top left speaker, a top right speaker, a left top speaker, a left bottom speaker, a right top speaker, a right bottom speaker, a bottom left speaker, a bottom right speaker, a front top left speaker, a front top right speaker, a front middle left speaker, a front middle right speaker, a front bottom left speaker, a front bottom right speaker, a back top left speaker, a back top right speaker, a back middle left speaker, a back middle right speaker, a back bottom left speaker, a back bottom right speaker, a speaker at any other location, or any combination thereof.

FIG. 6 illustrates yet another aspect of a PCD, generally designated 600. FIG. 6 shows the PCD 600 in cross-section. As shown, the PCD 600 may include a housing 602. In a particular aspect, one or more of the elements shown in conjunction with FIG. 3 may be disposed, or otherwise installed, within the inner housing 602. However, for clarity, only a processor 604 and a memory 606, connected thereto, are shown within the housing 602. Further, a directional speaker 608 may be connected to the processor 608.

The directional speaker 608 may serve as a 3D sound system. Further, as 3D virtual objects are displayed, the 3D sound system may be activated and may provide 3D sound associated with the 3D virtual object in accordance with one or more of the methods described herein.

It may be appreciated that the 3D sound system may direct sound in any direction relative to the PCD 600, e.g., to a top, a bottom, a left, a right, a front, a back, a top left, a top right, a left top, a left bottom, a right top, a right bottom, a bottom left, a bottom right, a front top left, a front top right, a front middle left, a front middle right, a front bottom left, a front bottom right, a back top left, a back top right, a back middle left, a back middle right, a back bottom left, a back bottom right, any other location, or any combination thereof.

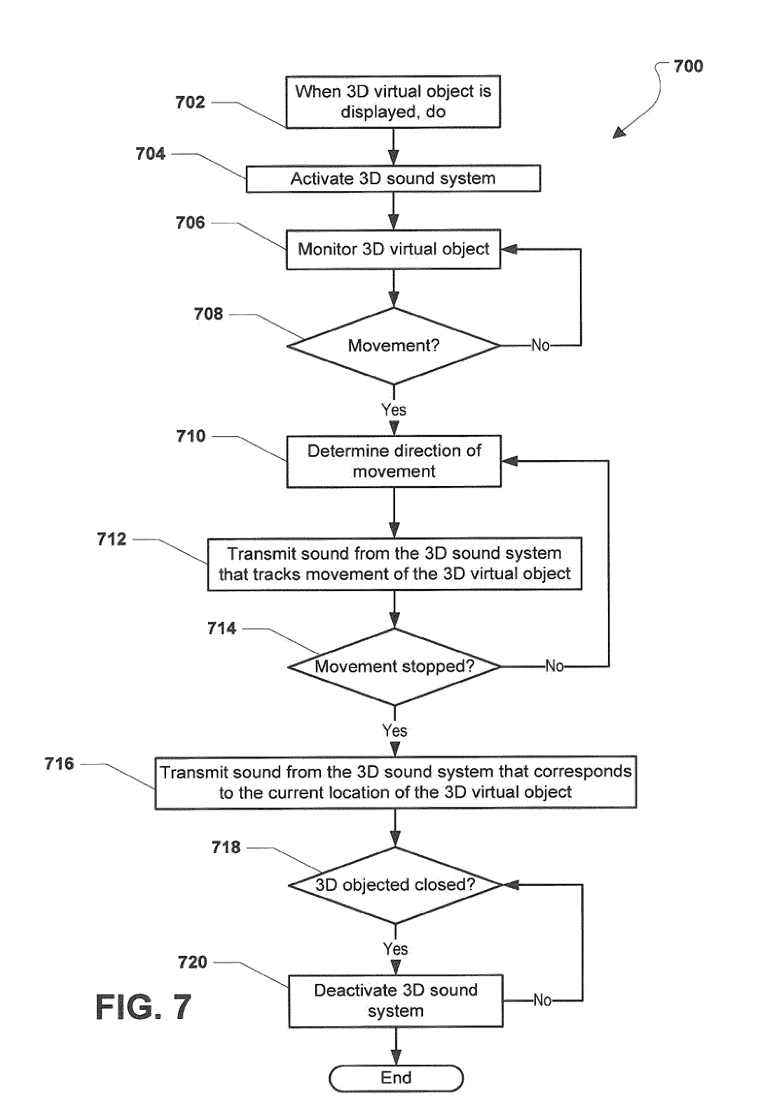

Referring now to FIG. 7, a first aspect of a method of transmitting three-dimensional sound from a wireless device is shown and is generally designated 700. Beginning at block 702, a do loop may be entered in which when a 3D virtual object is displayed the following steps may be performed. At block 704, a 3D sound system may be activated by a controller, processor, or a combination thereof. Further, at block 706, movement of the 3D virtual object may be monitored by a controller, a processor, or a combination thereof.

Continuing to decision 708, a controller may determine whether the 3D virtual object is moving within the display. The 3D object may move in response to a user input, e.g., a touch on a touchscreen or a sensor, or sensor array, disposed elsewhere on the device housing. Further, the 3D object may move as programmed for a particular software program. Also, the 3D object may move in response to a gestural input, e.g. a free-hand movement, a device in motion movement, or a combination thereof. If the 3D object is not moving, the method 700 may return block 706 and continue as described herein. Otherwise, if the 3D virtual object is moving within the display, the method 700 may move to block 710. At block 710, the controller may determine a direction of motion associated with the 3D virtual object. Next, at block 712, a controller may transmit sound from the 3D sound system that tracks the movement of the 3D virtual object.

Proceeding to decision 714, the controller may determine whether the movement of the 3D virtual object within the display has stopped. If the 3D virtual object continues to move within the display, the method 700 may return to block 710 and continue as described herein. Conversely, if the 3D virtual object has stopped moving, the method 700 may proceed to block 716 and the controller may transmit sound from the 3D sound system that corresponds to the current location of the 3D virtual object.

Next, at decision 718, the controller may determine whether the 3D virtual object is closed, i.e., whether the 3D virtual object continues to be displayed. If so, the method 700 may return to block 706 and continue as described herein. Otherwise, if the 3D virtual object is closed, the method 700 may move to block 720 and the controller may deactivate that 3D sound system, e.g., to conserve battery power. Thereafter, the method 700 may end.

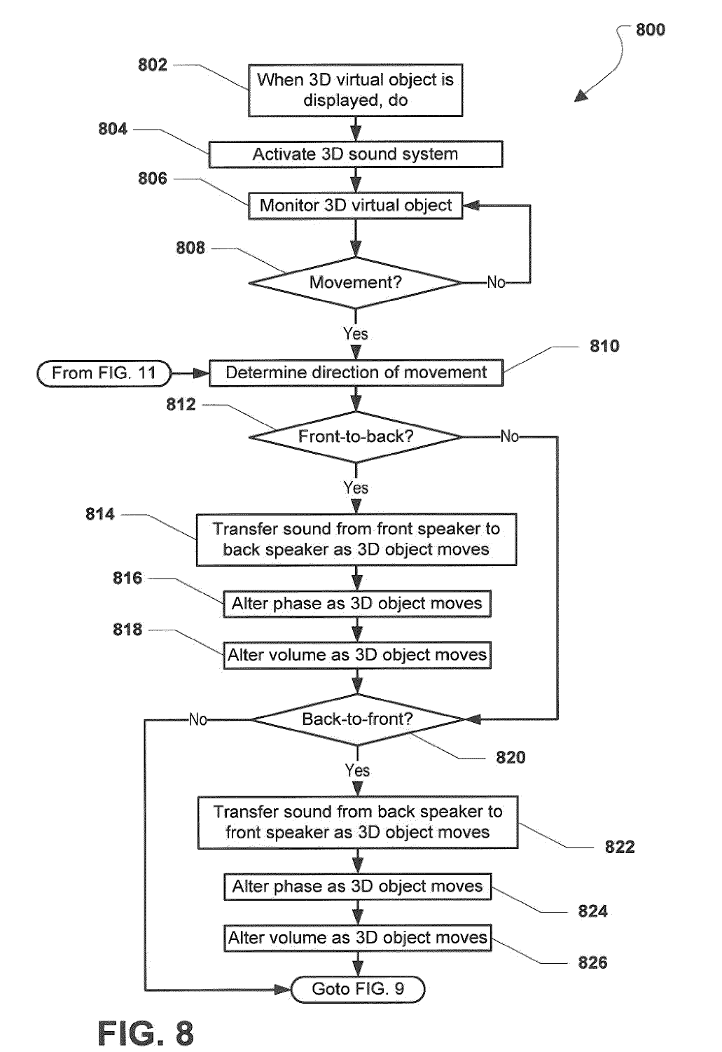

Referring now to FIG. 8, a second aspect of a method of transmitting three-dimensional sound from a wireless device is shown and is generally designated 800. Beginning at block 802, a do loop may be entered in which when a 3D virtual object is displayed the following steps may be performed. At block 804, a 3D sound system may be activated by a controller, processor, or a combination thereof. Further, at block 806, movement of the 3D virtual object may be monitored by a controller, a processor, or a combination thereof.

Continuing to decision 808, a controller may determine whether the 3D virtual object is moving within the display. If not, the method 800 may return block 806 and continue as described herein. Otherwise, if the 3D virtual object is moving within the display, the method 800 may move to block 810. At block 810, the controller may determine a direction of motion associated with the 3D virtual object.

At decision 812, the controller may determine whether the motion associated with the 3D virtual object is front-to-back. If so, the method 800 may proceed to block 814 and the controller may transfer, or otherwise fade, sound from a front speaker to a back speaker as the 3D virtual object moves. At block 816, the controller may alter the phase of the sound as the 3D virtual object moves. Further, at block 818, the controller may alter the volume of the sound as the 3D virtual object moves. Additionally, the controller may alter the pitch of the sound, the tone of the sound, or a combination thereof, as the 3D virtual object moves. Thereafter, the method 800 may proceed to decision 820. Returning to decision 812, if the motion associated with the 3D virtual object is not front-to-back, the method 800 may move directly to decision 820.

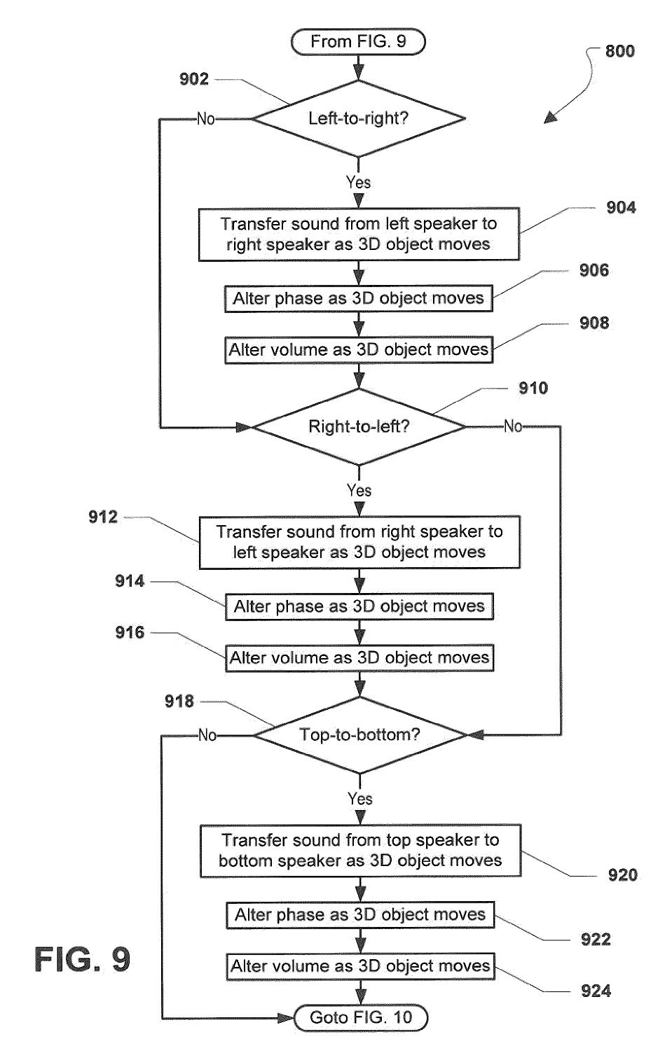

At decision 820, the controller may determine whether the motion associated with the 3D virtual object is back-to-front. If so, the method 800 may proceed to block 822 and the controller may transfer sound from a back speaker to a front speaker as the 3D virtual object moves. At block 824, the controller may alter the phase of the sound as the 3D virtual object moves. Further, at block 826, the controller may alter the volume of the sound as the 3D virtual object moves. Additionally, the controller may alter the pitch of the sound, the tone of the sound, or a combination thereof, as the 3D virtual object moves. Thereafter, the method 800 may proceed to decision 902 of FIG. 9. Returning to decision 820, if the motion associated with the 3D virtual object is not back-to-front, the method 800 may move directly to decision 902 of FIG. 9.

Referring now to FIG. 9, at decision 902, the controller may determine whether the motion associated with the 3D virtual object is left-to-right. If so, the method 800 may proceed to block 904 and the controller may transfer sound from a left speaker to a right speaker as the 3D virtual object moves. At block 906, the controller may alter the phase of the sound as the 3D virtual object moves. Further, at block 908, the controller may alter the volume of the sound as the 3D virtual object moves. Additionally, the controller may alter the pitch of the sound, the tone of the sound, or a combination thereof, as the 3D virtual object moves. Thereafter, the method 800 may proceed to decision 910. Returning to decision 902, if the motion associated with the 3D virtual object is not left-to-right, the method 800 may move directly to decision 910.

At decision 910, the controller may determine whether the motion associated with the 3D virtual object is right-to-left. If so, the method 800 may proceed to block 912 and the controller may transfer sound from a right speaker to a left speaker as the 3D virtual object moves. At block 914, the controller may alter the phase of the sound as the 3D virtual object moves. Further, at block 916, the controller may alter the volume of the sound as the 3D virtual object moves. Additionally, the controller may alter the pitch of the sound, the tone of the sound, or a combination thereof, as the 3D virtual object moves. Thereafter, the method 800 may proceed to decision 918. Returning to decision 910, if the motion associated with the 3D virtual object is not right-to-left, the method 800 may move directly to decision 918.

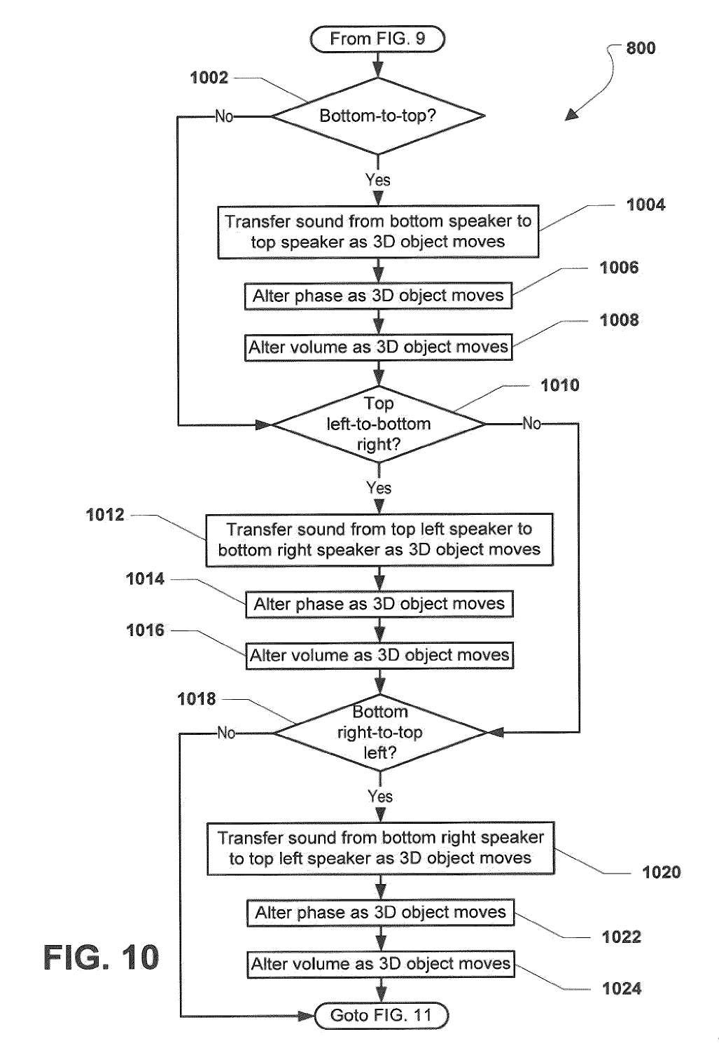

At decision 918, the controller may determine whether the motion associated with the 3D virtual object is top-to-bottom. If so, the method 800 may proceed to block 920 and the controller may transfer sound from a top speaker to a bottom speaker as the 3D virtual object moves. At block 922, the controller may alter the phase of the sound as the 3D virtual object moves. Further, at block 924, the controller may alter the volume of the sound as the 3D virtual object moves. Additionally, the controller may alter the pitch of the sound, the tone of the sound, or a combination thereof, as the 3D virtual object moves. Thereafter, the method 800 may proceed to decision 1002 of FIG. 10. Returning to decision 918, if the motion associated with the 3D virtual object is not top-to-bottom, the method 800 may move directly to decision 1002 of FIG. 10.

FIG. 10 illustrates that at decision 1002, the controller may determine whether the motion associated with the 3D virtual object is bottom-to-top. If so, the method 800 may proceed to block 1004 and the controller may transfer sound from a bottom speaker to a top speaker as the 3D virtual object moves. At block 1006, the controller may alter the phase of the sound as the 3D virtual object moves. Further, at block 1008, the controller may alter the volume of the sound as the 3D virtual object moves. Additionally, the controller may alter the pitch of the sound, the tone of the sound, or a combination thereof, as the 3D virtual object moves. Thereafter, the method 800 may proceed to decision 1010. Returning to decision 1002, if the motion associated with the 3D virtual object is not bottom-to-top, the method 800 may move directly to decision 1010.

At decision 1010, the controller may determine whether the motion associated with the 3D virtual object is top left-to-bottom right. If so, the method 800 may proceed to block 1012 and the controller may transfer sound from a top left speaker to a bottom right speaker as the 3D virtual object moves. At block 1014, the controller may alter the phase of the sound as the 3D virtual object moves. Further, at block 1016, the controller may alter the volume of the sound as the 3D virtual object moves. Additionally, the controller may alter the pitch of the sound, the tone of the sound, or a combination thereof, as the 3D virtual object moves. Thereafter, the method 800 may proceed to decision 1018. Returning to decision 1010, if the motion associated with the 3D virtual object is not top left-to-bottom right, the method 800 may move directly to decision 1018.

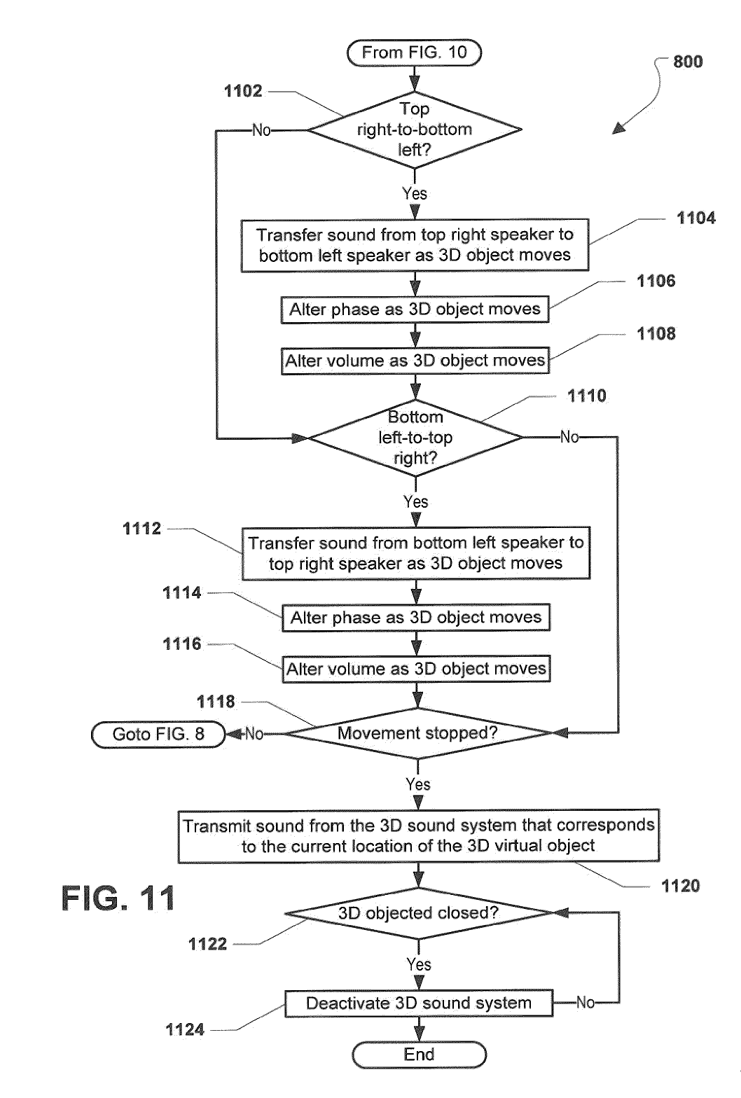

At decision 1018, the controller may determine whether the motion associated with the 3D virtual object is bottom right-to-top left. If so, the method 800 may proceed to block 1020 and the controller may transfer sound from a bottom right speaker to a top left speaker as the 3D virtual object moves. At block 1022, the controller may alter the phase of the sound as the 3D virtual object moves. Further, at block 1024, the controller may alter the volume of the sound as the 3D virtual object moves. Additionally, the controller may alter the pitch of the sound, the tone of the sound, or a combination thereof, as the 3D virtual object moves. Thereafter, the method 800 may proceed to decision 1102 of FIG. 11. Returning to decision 1018, if the motion associated with the 3D virtual object is not bottom right-to-top left, the method 800 may move directly to decision 1102 of FIG. 11.

Referring to FIG. 11, at decision 1102, the controller may determine whether the motion associated with the 3D virtual object is top right-to-bottom left. If so, the method 800 may proceed to block 1104 and the controller may transfer sound from a top right speaker to a bottom left speaker as the 3D virtual object moves. At block 1106, the controller may alter the phase of the sound as the 3D virtual object moves. Further, at block 1108, the controller may alter the volume of the sound as the 3D virtual object moves. Additionally, the controller may alter the pitch of the sound, the tone of the sound, or a combination thereof, as the 3D virtual object moves. Thereafter, the method 800 may proceed to decision 1110. Returning to decision 1102, if the motion associated with the 3D virtual object is not top right-to-bottom left, the method 800 may move directly to decision 1110.

At decision 1110, the controller may determine whether the motion associated with the 3D virtual object is bottom left-to-top right. If so, the method 800 may proceed to block 1112 and the controller may transfer sound from a bottom left speaker to a top right speaker as the 3D virtual object moves. At block 1114, the controller may alter the phase of the sound as the 3D virtual object moves. Further, at block 1116, the controller may alter the volume of the sound as the 3D virtual object moves. Additionally, the controller may alter the pitch of the sound, the tone of the sound, or a combination thereof, as the 3D virtual object moves. Thereafter, the method 800 may proceed to decision 1118. Returning to decision 1110, if the motion associated with the 3D virtual object is not bottom left-to-top right, the method 800 may move directly to decision 1118.

Proceeding to decision 1118, the controller may determine whether the movement of the 3D virtual object within the display has stopped. If the 3D virtual object continues to move within the display, the method 800 may return to block 810 of FIG. 8 and continue as described herein. Conversely, if the 3D virtual object has stopped moving, the method 800 may proceed to block 1120 and the controller may transmit sound from the 3D sound system that corresponds to the current location of the 3D virtual object.

Next, at decision 1122, the controller may determine whether the 3D virtual object is closed, i.e., whether the 3D virtual object continues to be displayed. If so, the method 800 may return to block 806 of FIG. 8 and continue as described herein. Otherwise, if the 3D virtual object is closed, the method 800 may move to block 1124 and the controller may deactivate that 3D sound system, e.g., to conserve battery power. Thereafter, the method 800 may end.

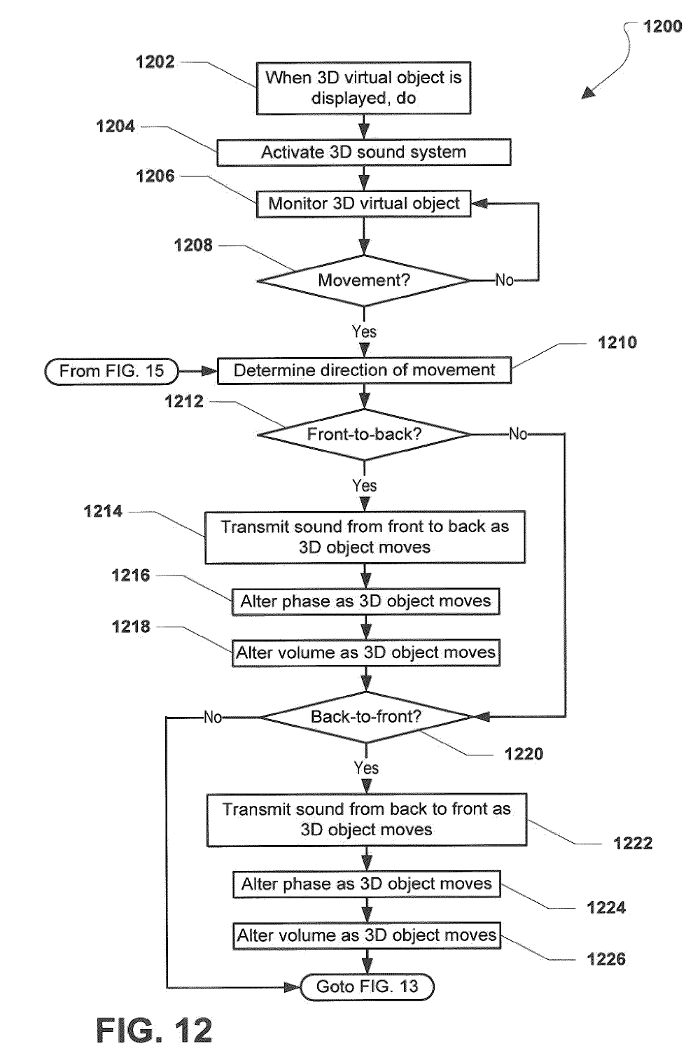

Referring now to FIG. 12, a second aspect of a method of transmitting three-dimensional sound from a wireless device is shown and is generally designated 1200. Beginning at block 1202, a do loop may be entered in which when a 3D virtual object is displayed the following steps may be performed. At block 1204, a 3D sound system may be activated by a controller, processor, or a combination thereof. Further, at block 1206, movement of the 3D virtual object may be monitored by a controller, a processor, or a combination thereof.

Continuing to decision 1208, a controller may determine whether the 3D virtual object is moving within the display. If not, the method 1200 may return block 1206 and continue as described herein. Otherwise, if the 3D virtual object is moving within the display, the method 1200 may move to block 1210. At block 1210, the controller may determine a direction of motion associated with the 3D virtual object.

At decision 1212, the controller may determine whether the motion associated with the 3D virtual object is front-to-back. If so, the method 1200 may proceed to block 1214 and the controller may direct, or otherwise transmit, sound from a front of the device to a back of the device as the 3D virtual object moves. At block 1216, the controller may alter the phase of the sound as the 3D virtual object moves. Further, at block 1218, the controller may alter the volume of the sound as the 3D virtual object moves. Additionally, the controller may alter the pitch of the sound, the tone of the sound, or a combination thereof, as the 3D virtual object moves. Thereafter, the method 1200 may proceed to decision 1220. Returning to decision 1212, if the motion associated with the 3D virtual object is not front-to-back, the method 1200 may move directly to decision 1220.

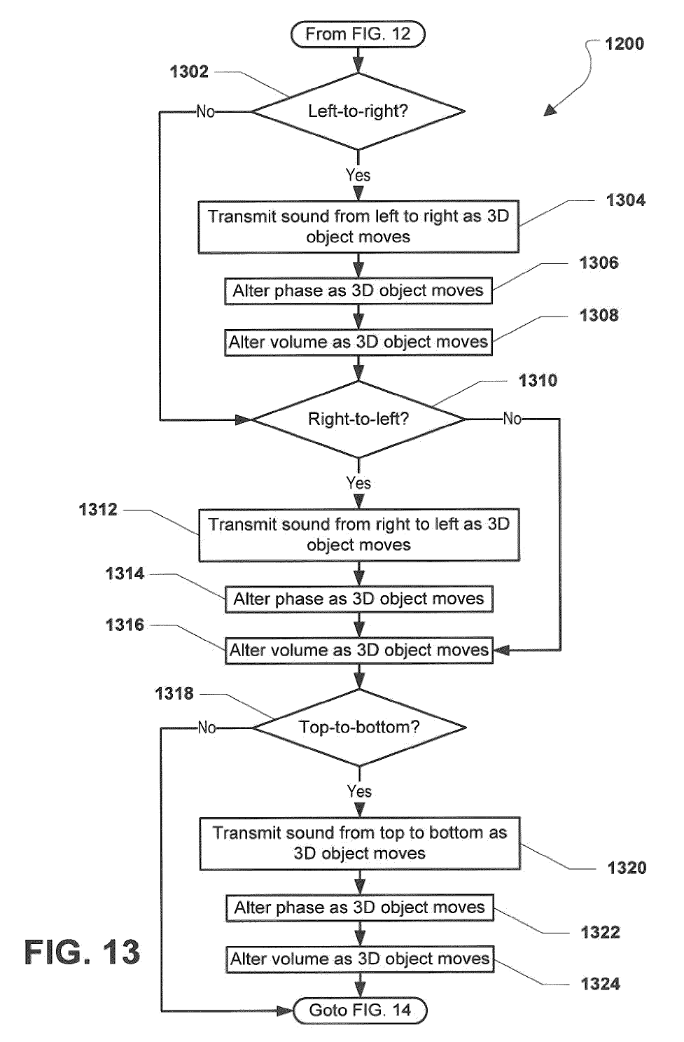

At decision 1220, the controller may determine whether the motion associated with the 3D virtual object is back-to-front. If so, the method 1200 may proceed to block 1222 and the controller may direct, or otherwise transmit, sound from a back of the device to a front of the device as the 3D virtual object moves. At block 1224, the controller may alter the phase of the sound as the 3D virtual object moves. Further, at block 1226, the controller may alter the volume of the sound as the 3D virtual object moves. Additionally, the controller may alter the pitch of the sound, the tone of the sound, or a combination thereof, as the 3D virtual object moves. Thereafter, the method 1200 may proceed to decision 1302 of FIG. 13. Returning to decision 1220, if the motion associated with the 3D virtual object is not back-to-front, the method 1200 may move directly to decision 1302 of FIG. 13.

Referring now to FIG. 13, at decision 1302, the controller may determine whether the motion associated with the 3D virtual object is left-to-right. If so, the method 1200 may proceed to block 1304 and the controller may direct, or otherwise transmit, sound from a left side of the device to a right side of the device as the 3D virtual object moves. At block 1306, the controller may alter the phase of the sound as the 3D virtual object moves. Further, at block 1308, the controller may alter the volume of the sound as the 3D virtual object moves. Additionally, the controller may alter the pitch of the sound, the tone of the sound, or a combination thereof, as the 3D virtual object moves. Thereafter, the method 1200 may proceed to decision 1310. Returning to decision 1302, if the motion associated with the 3D virtual object is not left-to-right, the method 1200 may move directly to decision 1310.

At decision 1310, the controller may determine whether the motion associated with the 3D virtual object is right-to-left. If so, the method 1200 may proceed to block 1312 and the controller may direct, or otherwise transmit, sound from a right side of the device to a left side of the device as the 3D virtual object moves. At block 1314, the controller may alter the phase of the sound as the 3D virtual object moves. Further, at block 1316, the controller may alter the volume of the sound as the 3D virtual object moves. Additionally, the controller may alter the pitch of the sound, the tone of the sound, or a combination thereof, as the 3D virtual object moves. Thereafter, the method 1200 may proceed to decision 1318. Returning to decision 1310, if the motion associated with the 3D virtual object is not right-to-left, the method 1200 may move directly to decision 1318.

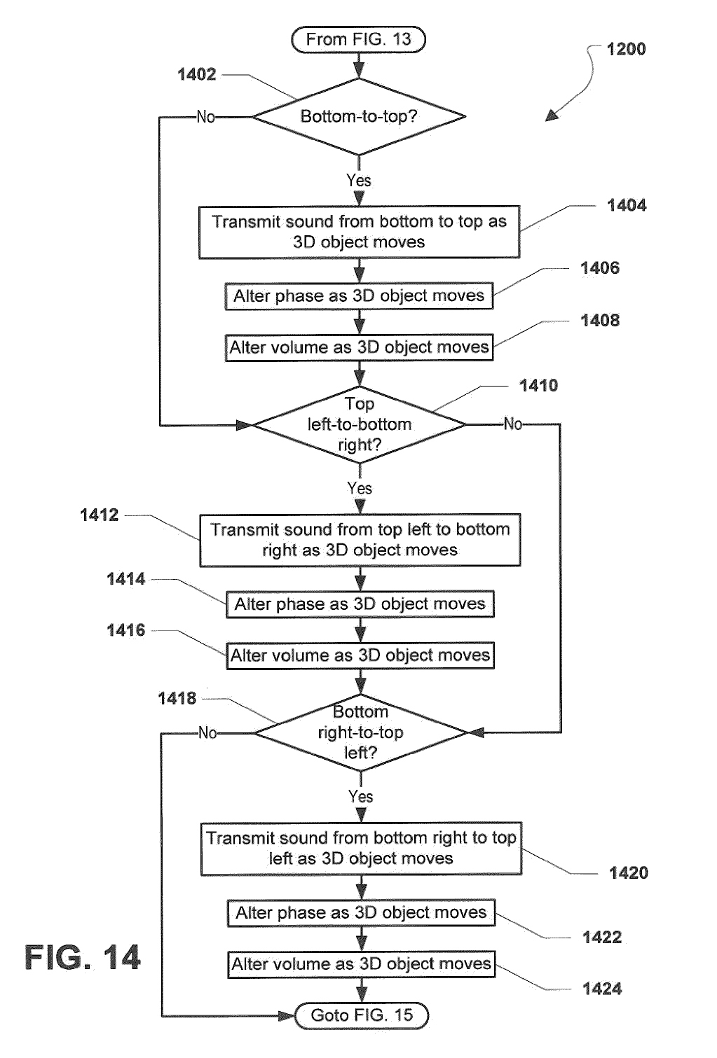

At decision 1318, the controller may determine whether the motion associated with the 3D virtual object is top-to-bottom. If so, the method 1200 may proceed to block 1320 and the controller may direct, or otherwise transmit, sound from a top of the device to a bottom of the device as the 3D virtual object moves. At block 1322, the controller may alter the phase of the sound as the 3D virtual object moves. Further, at block 1324, the controller may alter the volume of the sound as the 3D virtual object moves. Additionally, the controller may alter the pitch of the sound, the tone of the sound, or a combination thereof, as the 3D virtual object moves. Thereafter, the method 1200 may proceed to decision 1402 of FIG. 14. Returning to decision 1318, if the motion associated with the 3D virtual object is not top-to-bottom, the method 1200 may move directly to decision 1402 of FIG. 14.

FIG. 14 illustrates that at decision 1402, the controller may determine whether the motion associated with the 3D virtual object is bottom-to-top. If so, the method 1200 may proceed to block 1404 and the controller may direct, or otherwise transmit, sound from a bottom of the device to a top of the device as the 3D virtual object moves. At block 1406, the controller may alter the phase of the sound as the 3D virtual object moves. Further, at block 1408, the controller may alter the volume of the sound as the 3D virtual object moves. Additionally, the controller may alter the pitch of the sound, the tone of the sound, or a combination thereof, as the 3D virtual object moves. Thereafter, the method 1200 may proceed to decision 1410. Returning to decision 1402, if the motion associated with the 3D virtual object is not bottom-to-top, the method 1200 may move directly to decision 1410.

At decision 1410, the controller may determine whether the motion associated with the 3D virtual object is top left-to-bottom right. If so, the method 1200 may proceed to block 1412 and the controller may direct, or otherwise transmit, sound from a top left of the device to a bottom right of the device as the 3D virtual object moves. At block 1414, the controller may alter the phase of the sound as the 3D virtual object moves. Further, at block 1416, the controller may alter the volume of the sound as the 3D virtual object moves. Additionally, the controller may alter the pitch of the sound, the tone of the sound, or a combination thereof, as the 3D virtual object moves. Thereafter, the method 1200 may proceed to decision 1418. Returning to decision 1410, if the motion associated with the 3D virtual object is not top left-to-bottom right, the method 1200 may move directly to decision 1418.

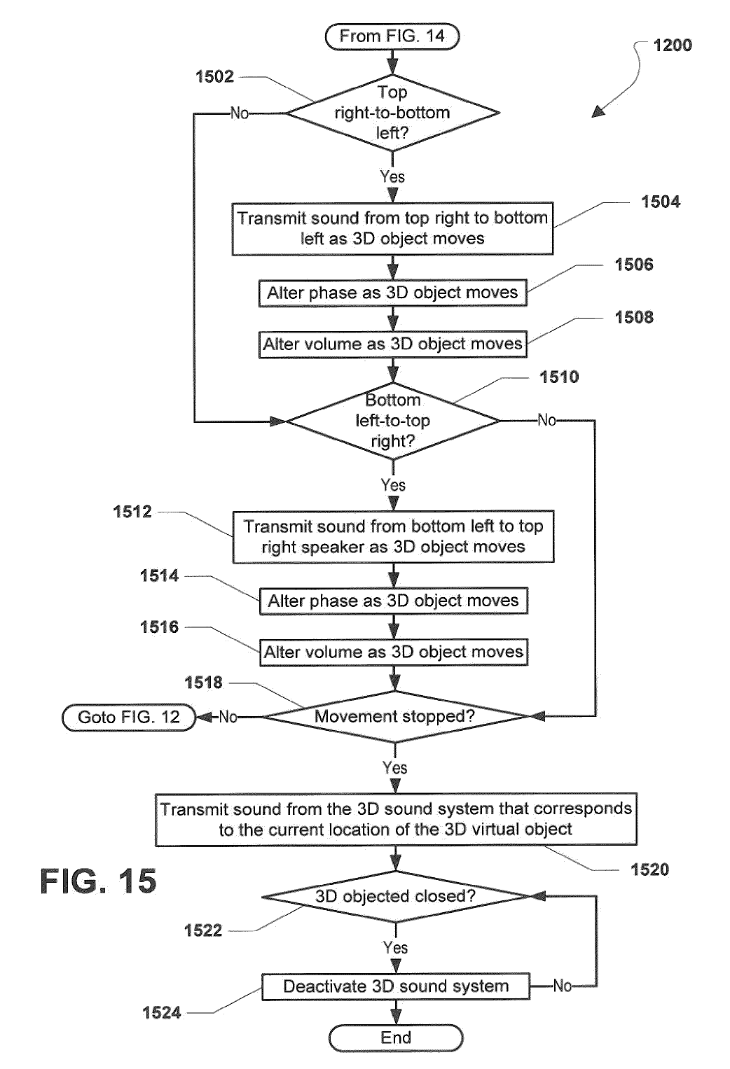

At decision 1418, the controller may determine whether the motion associated with the 3D virtual object is bottom right-to-top left. If so, the method 1200 may proceed to block 1420 and the controller may direct, or otherwise transmit, sound from a bottom right of the device to a top left of the device as the 3D virtual object moves. At block 1422, the controller may alter the phase of the sound as the 3D virtual object moves. Further, at block 1424, the controller may alter the volume of the sound as the 3D virtual object moves. Additionally, the controller may alter the pitch of the sound, the tone of the sound, or a combination thereof, as the 3D virtual object moves. Thereafter, the method 1200 may proceed to decision 1502 of FIG. 15. Returning to decision 1418, if the motion associated with the 3D virtual object is not bottom right-to-top left, the method 1200 may move directly to decision 1502 of FIG. 15.

Referring to FIG. 15, at decision 1502, the controller may determine whether the motion associated with the 3D virtual object is top right-to-bottom left. If so, the method 1200 may proceed to block 1504 and the controller may direct, or otherwise transmit, sound from a top right of the device to a bottom left of the device as the 3D virtual object moves. At block 1506, the controller may alter the phase of the sound as the 3D virtual object moves. Further, at block 1508, the controller may alter the volume of the sound as the 3D virtual object moves. Additionally, the controller may alter the pitch of the sound, the tone of the sound, or a combination thereof, as the 3D virtual object moves. Thereafter, the method 1200 may proceed to decision 1510. Returning to decision 1502, if the motion associated with the 3D virtual object is not top right-to-bottom left, the method 1200 may move directly to decision 1510.

At decision 1510, the controller may determine whether the motion associated with the 3D virtual object is bottom left-to-top right. If so, the method 1200 may proceed to block 1512 and the controller may direct, or otherwise transmit, sound from a bottom left of the device to a top right of the device as the 3D virtual object moves. At block 1511, the controller may alter the phase of the sound as the 3D virtual object moves. Further, at block 1516, the controller may alter the volume of the sound as the 3D virtual object moves. Additionally, the controller may alter the pitch of the sound, the tone of the sound, or a combination thereof; as the 3D virtual object moves. Thereafter, the method 1200 may proceed to decision 1518. Returning to decision 1510, if the motion associated with the 3D virtual object is not bottom left-to-top right, the method 1200 may move directly to decision 1518.

Proceeding to decision 1518, the controller may determine whether the movement of the 3D virtual object within the display has stopped. If the 3D virtual object continues to move within the display, the method 1200 may return to block 1210 of FIG. 12 and continue as described herein. Conversely, if the 3D virtual object has stopped moving, the method 1200 may proceed to block 1520 and the controller may transmit sound from the 3D sound system that corresponds to the current location of the 3D virtual object.

Next, at decision 1522, the controller may determine whether the 3D virtual object is closed, i.e., whether the 3D virtual object continues to be displayed. If so, the method 1200 may return to block 1206 of FIG. 12 and continue as described herein. Otherwise, if the 3D virtual object is closed, the method 1200 may move to block 1524 and the controller may deactivate that 3D sound system, e.g., to conserve battery power. Thereafter, the method 1200 may end.

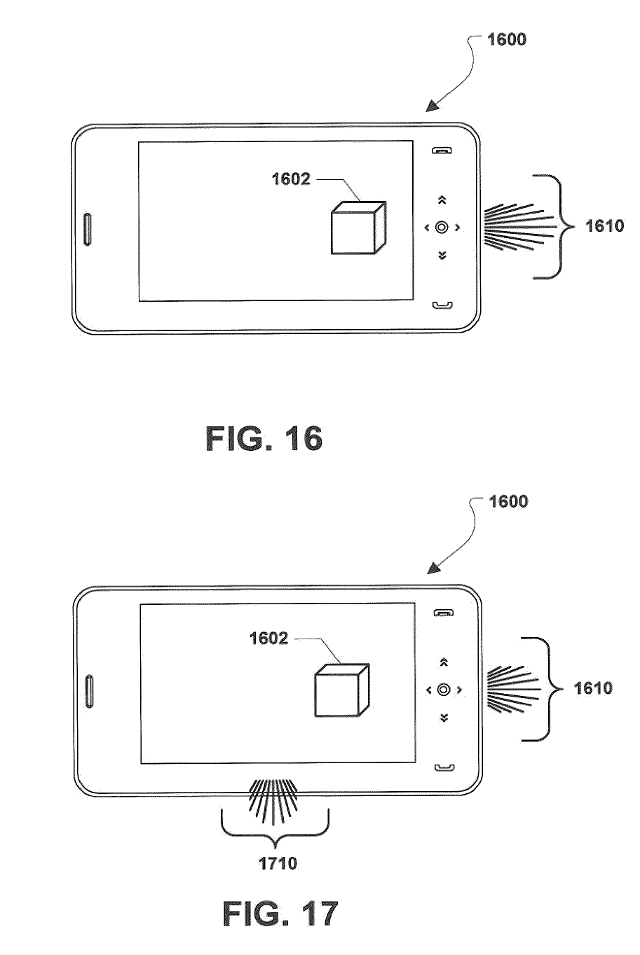

Referring now to FIG. 16, a portable computing device (PCD) is shown and is generally designated 1600. As illustrated, a 3D virtual object 1602 is displayed at the PCD 1600 at, or near, a right side of the PCD 1600. Further, a right sound component 1610 is shown emanating, or otherwise transmitting, from a right side speaker of the PCD 1600. In another aspect, the right sound component 1610 may be directed to the right side of the PCD 1600.

FIG. 17 shows the 3D virtual object 1602 moving toward a left side of the PCD 1600. As the 3D virtual object 1602 moves a volume of the right sound component 1610 may be decreased and a center sound component 1710 may be introduced and slowly increased as the 3D virtual object 1602 continues to move to the left side of the PCD 1600. The center sound component 1710 may emanate, or otherwise transmit, from a center speaker. Otherwise, the center sound component 1710 may be directed to the center of the PCD 1600.

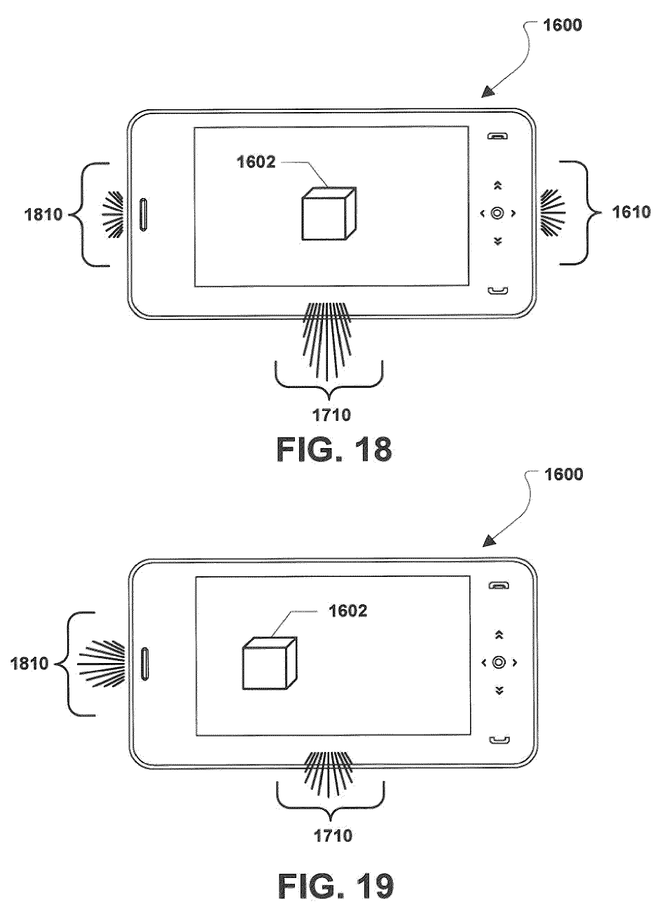

As depicted in FIG. 18, when the 3D virtual object 1602 moves into the center of the PCD 1600 the volume of the right sound component 1610 may be decreased, a volume of the center sound component 1710 may be increased, and a left sound component 1810 may be introduced and slowly increased as the 3D virtual object 1602 continues to move to the left side of the PCD 1600. The left sound component 1810 may emanate, or otherwise transmit, from a left speaker. Alternatively, the left sound component 1810 may be directed to the left of the PCD 1600.

FIG. 19 shows the 3D virtual object 1602 as it moves closer to the left side of the PCD 1600. As the 3D virtual object 1602 moves closer to the left side of the PCD 1600, the volume of the right sound component 1610 may be decreased until the right sound component 1610 is eliminated. Further, the volume of the center sound component 1710 may be decreased and the volume of the left sound component 1810 may be increased.

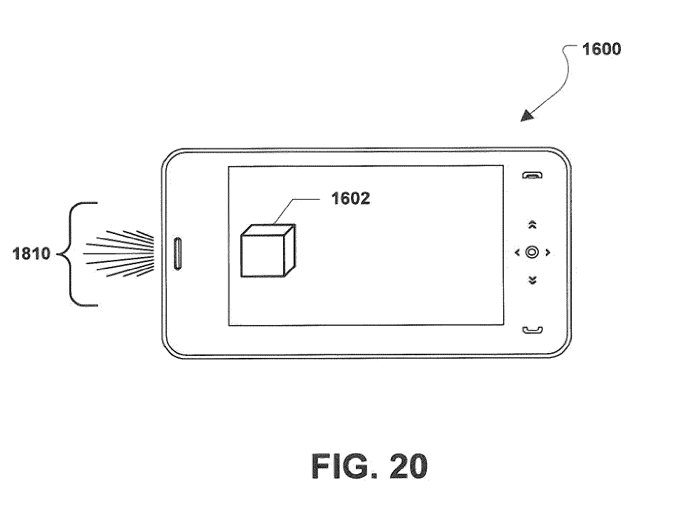

Referring to FIG. 20, the 3D virtual object 1602 is shown at, or near, the left side of the PCD 1600. When the 3D virtual object 1602 is at, or near, the left side of the PCD 1600, the volume of the center sound component 1710 may be decreased until the center sound component 1710 is eliminated. Further, the volume of the left sound component 1810 may be increased. Accordingly, only the left sound component 1810 is present when the 3D virtual object 1602 is at, or near, the left side of the PCD 1600.

It may be appreciated that the sound may be transmitted, or directed, in a similar fashion as illustrated in FIG. 16 through FIG. 20, and as described elsewhere herein, as the 3D virtual object moves in any direction or directions at the PCD 1600.

It is to be understood that the method steps described herein need not necessarily be performed in the order as described. Further, words such as “thereafter,” “then,” “next,” etc. are not intended to limit the order of the steps. These words are simply used to guide the reader through the description of the method steps. Moreover, the methods described herein are described as executable on a portable computing device (PCD). The PCD may be a mobile telephone device, a portable digital assistant device, a smartbook computing device, a netbook computing device, a laptop computing device, a desktop computing device, or a combination thereof.

With the configuration of structure describe herein, the system and method provides 3D sound that tracks the movement of a 3D virtual object within a display of a portable computing device. While the 3D virtual object moves within the display, a 3D sound controller may transmit sound from various speakers at the portable computing device corresponding to the motion of the 3D virtual object. Alternatively, the 3D sound controller may direct sound from a directional speaker at the portable computing device that corresponds to the motion of the 3D virtual object.

The 3D sound system may be used to provide 3D sound for games. Further, the 3D sound system may provide 3D sounds in conjunction with a user moving 3D menu items around a display, e.g., back and forth in the display. Moreover, the 3D sound system may provide 3D sound for navigation applications. Also, the 3D sound system may provide spatial sounds for handicap users of portable computing devices. During movement, a controller may interpret a user input ur a 3D object movement and change the 3D sound according to, or in response to, the movement of the 3D object or the user input.

In one or more exemplary aspects, the functions described may be implemented in hardware, software, firmware, or any combination thereof. If implemented in software, the functions may be stored on or transmitted over as one or more instructions or code on a machine readable medium, i.e., a computer-readable medium. Computer-readable media includes both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Although selected aspects have been illustrated and described in detail, it will be understood that various substitutions and alterations may be made therein without departing from the spirit and scope of the present invention, as defined by the following claims.

What is claimed is:

1. A method of providing three-dimensional (3D) sound at a wireless device, the method comprising:
detecting movement of a 3D virtual object within a display;
determining a direction of the movement of the 3D virtual object; and
transmitting sound from a 3D sound system that tracks the direction of the movement of the 3D virtual object.

2. The method of claim 1, further comprising:
selectively altering a phase of the sound as the 3D virtual object moves.

3. The method of claim 2, further comprising:
selectively altering a volume of the sound as the 3D virtual object moves.

4. The method of claim 3, further comprising:
selective altering a pitch of the sound as the 3D virtual object moves.

5. The method of claim 4, further comprising:
selectively altering a tone of the sound as the 3D virtual object moves.

6. The method of claim 1, wherein the 3D sound system comprises a plurality of speakers installed within the wireless device.

7. The method of claim 6, further comprising:
transferring the sound around the plurality of speakers as the 3D virtual object moves to track the movement of the 3D virtual object.

8. The method of claim 1, wherein the 3D sound system comprises at least one directional speaker installed within the wireless device.

9. The method of claim 8, further comprising:
directing the sound around the wireless device as the 3D virtual object moves to track the movement of the 3D virtual object.

10. The method of claim 1, further comprising:
detecting when the 3D virtual object has stopped moving; and
transmitting sound from the 3D sound system that corresponds to a current location of the 3D virtual object.

11. A portable computing device, comprising:
a processor, wherein the processor is operable to:
detect movement of a 3D virtual object within a display;
determine a direction of the movement of the 3D virtual object; and
transmit sound from a 3D sound system that tracks the direction of the movement of the 3D virtual object.

12. The device of claim 11, wherein the processor is further operable to:
selectively alter a phase of the sound as the 3D virtual object moves.

13. The device of claim 12, wherein the processor is further operable to:
selectively alter a volume of the sound as the 3D virtual object moves.

14. The device of claim 13, wherein the processor is further operable to:
selective alter a pitch of the sound as the 3D virtual object moves.

15. The device of claim 14, wherein the processor is further operable to:
selectively alter a tone of the sound as the 3D virtual object moves.

16. The device of claim 11, wherein the 3D sound system comprises a plurality of speakers installed within the wireless device.

17. The device of claim 16, wherein the processor is further operable to:
transfer the sound around the plurality of speakers as the 3D virtual object moves to track the movement of the 3D virtual object.

18. The device of claim 11, wherein the 3D sound system comprises at least one directional speaker installed within the wireless device.

19. The device of claim 18, wherein the processor is further operable to:
direct the sound around the wireless device as the 3D virtual object moves to track the movement of the 3D virtual object.

20. The device of claim 11, wherein the processor is further operable to:
detect when the 3D virtual object has stopped moving; and
transmit sound from the 3D sound system that corresponds to a current location of the 3D virtual object.

21. A portable computing device, comprising:
means for detecting movement of a 3D virtual object within a display;
means for determining a direction of the movement of the 3D virtual object; and
means for transmitting sound from a 3D sound system that tracks the direction of the movement of the 3D virtual object.

22. The device of claim 21, further comprising:
means for selectively altering a phase of the sound as the 3D virtual object moves.

23. The device of claim 22, further comprising:
means for selectively altering a volume of the sound as the 3D virtual object moves.

24. The device of claim 23, further comprising:
means for selective altering a pitch of the sound as the 3D virtual object moves.

25. The device of claim 24, further comprising:
means for selectively altering a tone of the sound as the 3D virtual object moves.

26. The device of claim 21, wherein the 3D sound system comprises a plurality of speakers installed within the wireless device.

27. The device of claim 26, further comprising:
means for transferring the sound around the plurality of speakers as the 3D virtual object moves to track the movement of the 3D virtual object.

28. The device of claim 21, wherein the 3D sound system comprises at least one directional speaker installed within the wireless device.

29. The device of claim 28, further comprising:
means for directing the sound around the wireless device as the 3D virtual object moves to track the movement of the 3D virtual object.

30. The device of claim 21, further comprising:
means for detecting when the 3D virtual object has stopped moving; and
means for transmitting sound from the 3D sound system that corresponds to a current location of the 3D virtual object.

31. A machine readable medium, comprising:
at least one instruction for detecting movement of a 3D virtual object within a display;
at least one instruction for determining a direction of the movement of the 3D virtual object; and
at least one instruction for transmitting sound from a 3D sound system that tracks the direction of the movement of the 3D virtual object.

32. The machine readable medium of claim 31, further comprising:
at least one instruction for selectively altering a phase of the sound as the 3D virtual object moves.

33. The machine readable medium of claim 32, further comprising:
at least one instruction for selectively altering a volume of the sound as the 3D virtual object moves.

34. The machine readable medium of claim 33, further comprising:
at least one instruction for selective altering a pitch of the sound as the 3D virtual object moves.

35. The machine readable medium of claim 34, further comprising:
at least one instruction for selectively altering a tone of the sound as the 3D virtual object moves.

36. The machine readable medium of claim 31, wherein the 3D sound system comprises a plurality of speakers installed within a wireless device.

37. The machine readable medium of claim 36, further comprising:
at least one instruction for transferring the sound around the plurality of speakers as the 3D virtual object moves to track the movement of the 3D virtual object.

38. The machine readable medium of claim 31, wherein the 3D sound system comprises at least one directional speaker installed within a wireless device.

39. The machine readable medium of claim 38, further comprising:
at least one instruction for directing the sound around the wireless device as the 3D virtual object moves to track the movement of the 3D virtual object.

40. The machine readable medium of claim 31, further comprising:
at least one instruction for detecting when the 3D virtual object has stopped moving; and
at least one instruction for transmitting sound from the 3D sound system that corresponds to a current location of the 3D virtual object.
